(19) United States
(12) Patent Application Publication
(10) Pub. No.: US 2020/0387153 A1
(43) Pub. Date: Dec. 10, 2020

(54) PARKING LOT MANAGEMENT SYSTEM, PARKING LOT MANAGEMENT DEVICE, PARKING LOT MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/865,439

(22) Filed: May 4, 2020

(30) Foreign Application Priority Data
May 13, 2019 (JP) 2019-090829

(51) Int. Cl. G05D 1/00; B60W 30/06; G06Q 10/06

(52) U.S. Cl. CPC G05D 1/0011; B60W 30/06; G06Q 10/02; G05D 2201/0213; G06Q 10/06312

(57) ABSTRACT

A parking lot management system including a vehicle using a parking lot, a vehicle control application to be executed by a terminal device used by a user of the vehicle, and a management device which is capable of communicating with the vehicle and the vehicle control application and manages at least one of a parking position, a movement trajectory, and a movement order of the vehicle using the parking lot. When communication with the vehicle control application has failed, the management device causes the vehicle and the vehicle control application to perform direct communication and acquires a communication result.

### CROSS-REFERENCE TO RELATED APPLICATION

Priority is claimed on Japanese Patent Application No. 2019-090829, filed May 13, 2019, the content of which is incorporated herein by reference.

### BACKGROUND OF THE INVENTION

### Field of the Invention

The present invention relates to a parking lot management system, a parking lot management device, a parking lot management method, and a storage medium.

### Description of Related Art

Conventionally, technology for determining the leaving of a vehicle without installing a dedicated device (a parking lot management device) in a parking lot using a portable terminal for managing the vehicle within the parking lot is disclosed (for example, Japanese Unexamined Patent Application, First Publication No. 2018-196018).

### SUMMARY OF THE INVENTION

However, in the conventional technology, there is a possibility that appropriate management control cannot be executed in a situation where a vehicle leaves a parking lot when communication between a communication terminal for determining the leaving of the vehicle and the vehicle is not performed normally or when communication between a portable terminal and a server device is not performed normally.

Aspects of the present invention have been made in consideration of such circumstances and an objective of the present invention is to provide a parking lot management system, a parking lot management device, a parking lot management method, and a storage medium capable of executing more appropriate parking lot management control.

In order to achieve the objective by solving the above-described problems, the present invention adopts the following aspects.

(1): According to an aspect of the present invention, a parking lot management system is provided comprising an in-vehicle communication device mounted in a vehicle, a vehicle control application to be executed by a terminal device used by a user of the vehicle and having a communication function, and a management device which is capable of communicating with the in-vehicle communication device and the terminal device and manages at least one of a parking position, a movement trajectory, and a movement order of the vehicle using a parking lot in accordance with an instruction from the vehicle control application, wherein, when communication between the management device and the terminal device has succeeded, the in-vehicle communication device acquires the instruction from the vehicle control application via the management device, and wherein, when the communication between the management device and the terminal device has failed, the in-vehicle communication device acquires information from the vehicle control application through communication with the terminal device, transmits the information acquired from the vehicle control application to the management device, and transmits a result of communicating with the management device to the vehicle control application.

(2): In the above-described aspect (1), the management device may manage at least one of the parking position, the movement trajectory, and the movement order of the vehicle using the parking lot on the basis of information acquired from the in-vehicle communication device.

(3): In the above-described aspect (1) or (2), the management device may communicate with the terminal device, acquire information from the vehicle control application, accumulate the information in a storage unit, and transmit a processing result to the vehicle control application.

(4): In the above-described aspect (1) or (2), the management device may cause parking lot use state information, which is information about a use state of the parking lot, to be stored in a storage unit and manages the parking lot use state information, and, when the parking lot use state information has been reset, the management device may acquire a part or all of information of vehicles using the parking lot from the in-vehicle communication device and reconstruct the parking lot use state information on the basis of the acquired information.

(5): In the above-described aspect (4), the parking lot use state information may include some or all of a parking lot entering time of the vehicle, a movement trajectory at the time of entering, a scheduled departure time, and the presence or absence of designation of a platform to be used by the vehicle.

(6): In the above-described aspect (4) or (5), when the parking lot use state information has been reset, the management device may temporarily restrict the vehicle from entering and leaving the parking lot.

(7): In the above-described aspect (6), when a state in which there is no acquisition of information from the in-vehicle communication device has continued for a predetermined time period or more, the management device may determine that reconstruction of the parking lot use state information has been completed and release the restriction on the leaving of the vehicle.

(8): According to an aspect of the present invention, a parking lot management device is provided comprising a first communication unit configured to communicate with an in-vehicle communication device mounted in a vehicle within a parking lot, a second communication unit configured to communicate with a terminal device used by a user of the vehicle, and a control unit configured to integrate a result of communication of the first communication unit with the in-vehicle communication device and a result of communication of the second communication unit with the terminal device to control a parking lot use state of the vehicle, wherein, when the communication of the second communication unit has failed, the control unit causes the first communication unit to acquire a result of direct communication of the in-vehicle communication device with the terminal device from the in-vehicle communication device.

(9): According to an aspect of the present invention, a parking lot management method is provided to be executed by an in-vehicle communication device mounted in a vehicle, a vehicle control application to be executed by a terminal device used by a user of the vehicle and having a communication function, and a management device which is capable of communicating with the in-vehicle communication device and the terminal device, the parking lot management method including: managing, by the management device, at least one of a parking position, a movement trajectory, and a movement order of the vehicle using the parking lot in accordance with an instruction from the vehicle control application; when communication between the management device and the terminal device has succeeded, acquiring, by the in-vehicle communication device, the instruction from the vehicle control application via the management device; and when communication between the management device and the terminal device has failed, acquiring, by the in-vehicle communication device, information from the vehicle control application through communication with the terminal device, transmitting the information acquired from the vehicle control application to the management device, and transmitting a result of communicating with the management device to the vehicle control application.

(10): According to an aspect of the present invention, a computer-readable non-transitory storage medium is provided storing a program for causing a computer of a management device including a first communication unit configured to communicate with an in-vehicle communication device mounted in a vehicle within a parking lot and a second communication unit configured to communicate with a terminal device used by a user of the vehicle to: integrate a result of communication of the first communication unit with the in-vehicle communication device and a result of communication of the second communication unit with the terminal device to control a parking lot use state of the vehicle; when the communication of the second communication unit has succeeded, cause the first communication unit to receive an instruction from the user via the management device; and when the communication of the second communication unit has failed, cause the first communication unit to acquire a result of direct communication of the in-vehicle communication device with the terminal device from the in-vehicle communication device.

According to the above-described aspects (1) to (10), it is possible to execute more appropriate driving control in a situation in which a vehicle travels in an area including a parking lot.

### BRIEF DESCRIPTION OF THE DRAWINGS

FIG. 1 is a configuration diagram of a parking lot management system S according to an embodiment.

FIG. 2 is a configuration diagram of a vehicle system 1 including a vehicle control device.

FIG. 3 is a functional configuration diagram of a first control unit 120 and a second control unit 160.

FIG. 4 is a diagram showing an example of a functional configuration of a terminal device 300.

FIG. 5 is a diagram schematically showing a scene in which an autonomous parking event is executed in the embodiment.

FIG. 6 is a diagram showing an example of an image IM1 displayed on a display 330 of a terminal device 300 as an automated entering acceptance screen.

FIG. 7 is a diagram showing an example of an image IM2 for inputting a scheduled leaving time.

FIG. 8 is a diagram showing an example of a configuration of a parking lot management device 500.

FIG. 9 is a diagram for describing a traveling route recognition unit 134.

FIG. 10 is a diagram showing an example of an image IM3 displayed on the display 330 of the terminal device 300 as an automated leaving acceptance screen.

FIG. 11 is a diagram showing an example of an image IM4 indicating that an automated entering process cannot be executed.

FIG. 12 is a diagram showing an example of an image IM5 for inquiring about whether or not to directly issue a leaving instruction to a host vehicle M.

FIG. 13 is a diagram showing a process in which a parking situation management unit 524 reconstructs a parking space state table 534.

FIG. 14 is a flowchart showing an example of a flow of a process to be executed by an automated driving control device 100 according to the embodiment.

FIG. 15 is a flowchart showing an example of a flow of a process to be executed by the parking lot management device 500 of the embodiment.

FIG. 16 is a flowchart showing an example of a flow of a process to be executed by the terminal device 300 of the embodiment.

FIG. 17 is a diagram showing an example of a hardware configuration of the automated driving control device 100.

### DETAILED DESCRIPTION OF THE INVENTION

Hereinafter, embodiments of a parking lot management system, a parking lot management device, a parking lot management method, and a storage medium of the present invention will be described with reference to the drawings. Hereinafter, an example in which a vehicle equipped with an in-vehicle communication device is an automated driving vehicle will be described. The automated driving means, for example, automatedly controlling one or both of steering and acceleration/deceleration of the vehicle to execute the driving control. In the automated-driving vehicle, the driving control may be executed by a manual operation of an occupant in accordance with a situation.

### [Overall Configuration]

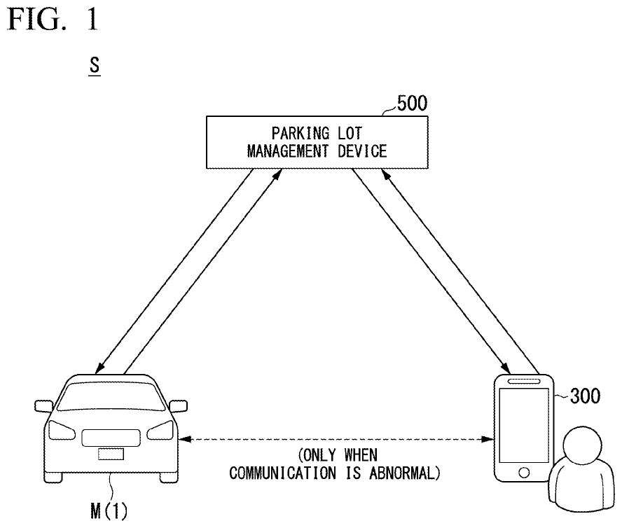

FIG. 1 is a configuration diagram of a parking lot management system S according to the embodiment. The parking lot management system S includes, for example, a host vehicle M, a terminal device 300, and a parking lot management device 500. The terminal device 300 is, for example, a terminal device used by an occupant of the host vehicle M. The host vehicle M is, for example, a vehicle equipped with a vehicle system 1 to be described below. The terminal device 300 is, for example, a portable terminal having a communication function such as a smartphone or a tablet terminal that the user U can possess. Hereinafter, it is assumed that the user U can be an occupant of the host vehicle M. The parking lot management device 500 controls entering and leaving of the host vehicle M in a parking lot while communicating with the host vehicle M or the terminal device 300. The parking lot management device 500 manages, for example, at least one of a parking position, a movement trajectory, and a movement order of a vehicle using the parking lot. The parking lot management device 500 is an example of a “management device”.

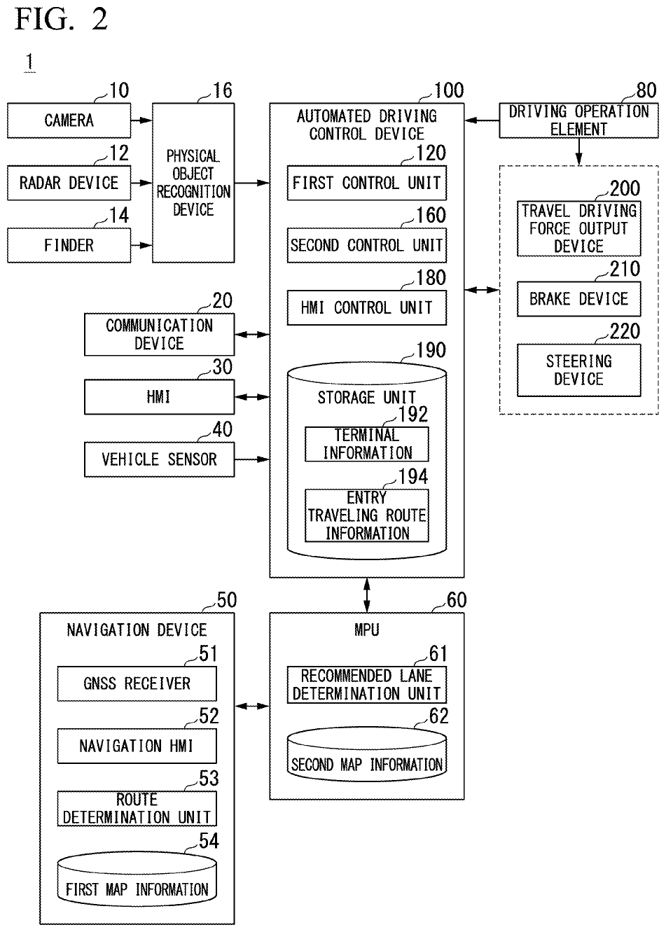

FIG. 2 is a configuration diagram of the vehicle system 1 including a vehicle control device. For example, a vehicle on which the vehicle system 1 is mounted is, for example, a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power generated by an electric power generator connected to the internal combustion engine or discharge electric power of a battery (a storage battery) such as a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operation element 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 2 is merely an example and a part of the configuration may be omitted or another configuration may be further added.

For example, the camera 10 is a digital camera using a solid-state imaging element such as a charge coupled device (CCD) or a complementary metal oxide semiconductor (CMOS). The camera 10 is attached to any position on the vehicle (hereinafter referred to as a host vehicle M) in which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position on the host vehicle M.

The physical object recognition device 16 performs a sensor fusion process on detection results of some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

For example, the communication device 20 communicates with the terminal device 300 of a user U using the host vehicle M, another vehicle present in the vicinity of the host vehicle M, the parking lot management device 500, or various types of server devices on the basis of a communication state using, for example, a cellular network or a Wi-Fi network, Bluetooth (registered trademark), dedicated short range communication (DSRC), a local area network (LAN), a wide area network (WAN), or a network such as the Internet. The user U may be, for example, an owner of the host vehicle M or a user who only uses the host vehicle M through a rental car service, a car sharing service, or the like. Also, the communication device 20, the terminal device 300, and the parking lot management device 500 are connected so that they can communicate with other devices. Hereinafter, communication with the communication device 20 may be referred to as communication with the host vehicle M in some cases. The communication device 20 is an example of an “in-vehicle communication device”.

The HMI 30 presents various types of information to an occupant of the host vehicle M and receives an input operation of the occupant. The HMI 30 includes a display device, a speaker for an interior of the vehicle, a buzzer, a touch panel, a switch, keys, and the like. The display device includes, for example, a meter display provided in a portion of an instrument panel facing a driver, a center display provided at the center of the instrument panel, a head up display (HUD), and the like. For example, the HUD is a device that allows the occupant to visually recognize an image by superimposing the image on a landscape. As an example, the HUD projects light including an image on a front windshield or a combiner of the host vehicle M, thereby allowing the occupant to visually recognize a virtual image.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like. The vehicle sensor 40 may include a load sensor configured to detect a load of a seat located in the interior of the vehicle. A detection result of the vehicle sensor 40 is output to the automated driving control device 100.

For example, the navigation device 50 includes a global navigation satellite system (GNSS) receiver 51, a navigation HMI 52, and a route determination unit 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determination unit 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of the terminal device 300. The navigation device 50 may transmit a current position and a destination to a navigation server via the communication device 20 and acquire a route equivalent to the route on the map from the navigation server. The navigation device 50 outputs the determined route on the map to the MPU 60.

For example, the MPU 60 includes a recommended lane determination unit 61 and stores second map information 62 in a storage device such as an HDD or a flash memory. The recommended lane determination unit 61 divides the route on the map provided from the navigation device 50 into a plurality of blocks (for example, divides the route every 100 [m] in a traveling direction of the vehicle), and determines a recommended lane for each block with reference to the second map information 62. The recommended lane determination unit 61 determines what number lane the vehicle travels in from the left. The recommended lane determination unit 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, parking lot information, telephone number information, and the like. The parking lot information includes, for example, a position and a shape of the parking lot, the number of vehicles that can be parked, the availability of automated driving, a getting-into/out area, a stopping area, and the like. The second map information 62 may be updated at any time when the communication device 20 communicates with another device.

For example, the driving operation element 80 includes an accelerator pedal, a brake pedal, a shift lever, a steering wheel, a steering wheel variant, a joystick, and other operation elements. A sensor configured to detect an amount of operation or the presence or absence of an operation is attached to the driving operation element 80, and a detection result thereof is output to the automated driving control device 100 or some or all of the travel driving force output device 200, the brake device 210, and the steering device 220.

The automated driving control device 100 includes, for example, a first control unit 120, a second control unit 160, the HMI control unit 180, and a storage unit 190. The first control unit 120, the second control unit 160, and the HMI control unit 180 are implemented, for example, by a hardware processor such as a central processing unit (CPU) executing a program (software). Also, some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by software and hardware in cooperation. The program may be pre-stored in a storage device of the automated driving control device 100 (a storage device including a non-transitory storage medium) or may be stored in a removable storage medium such as a DVD, a CD-ROM, or a memory card and installed in the storage device of the automated driving control device 100 when the storage medium (the non-transitory storage medium) is mounted in a drive device, a card slot, or the like.

The storage unit 190 is implemented by each storage device described above. Also, the storage unit 190 is implemented by, for example, an HDD, a flash memory, an EEPROM, a read only memory (ROM), a random access memory (RAM), or the like. For example, terminal information 192, storage traveling route information 194, programs, and other various types of information are stored in the storage unit 190.

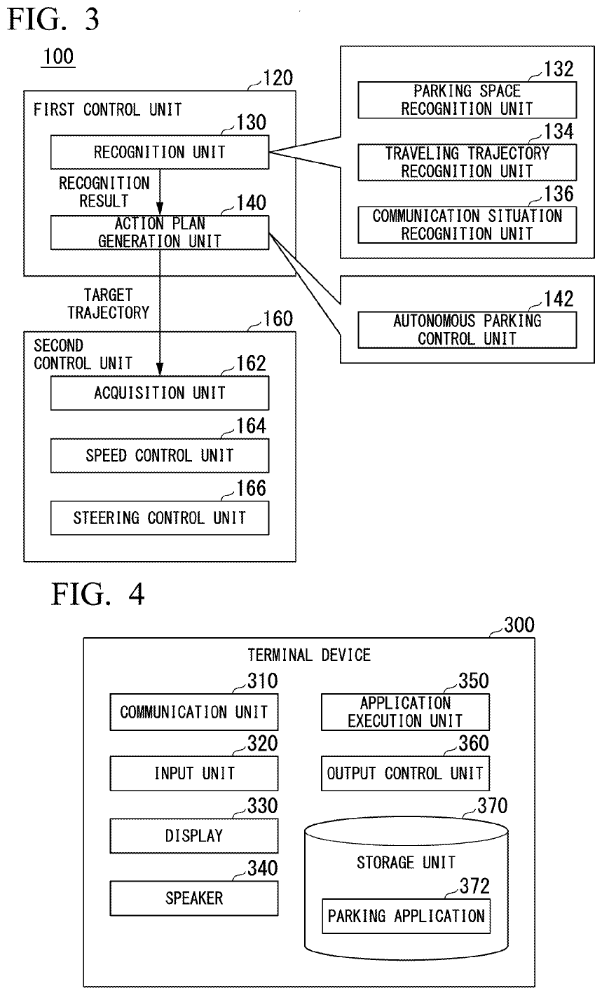

FIG. 3 is a functional configuration diagram of the first control unit 120 and the second control unit 160. The first control unit 120 includes, for example, a recognition unit 130 and an action plan generation unit 140. For example, the first control unit 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured. Also, the first control unit 120 executes control related to automated driving of the host vehicle M on the basis of, for example, an instruction from the MPU 60, the HMI control unit 180, or the like or an instruction from the terminal device 300.

The recognition unit 130 recognizes a surrounding environment of the host vehicle M on the basis of information input from the camera 10, the radar device 12, and the finder 14 via the physical object recognition device 16. The recognition unit 130 recognizes a position, a speed, acceleration, and the like of the physical object around the host vehicle M on the basis of the input information. For example, the physical object is a moving object such as another vehicle or an obstacle. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. When the physical object is a moving object such as another vehicle, the “state” of a physical object may include acceleration or jerk of the physical object or an “action state” (for example, whether or not a lane change is being made or intended).

Also, for example, the recognition unit 130 recognizes a lane in which the host vehicle M is traveling (a travel lane). For example, the recognition unit 130 recognizes the travel lane by comparing a pattern of a road dividing line (for example, an arrangement of solid lines and broken lines) obtained from the second map information 62 with a pattern of road dividing lines in the vicinity of the host vehicle M recognized from an image captured by the camera 10 (hereinafter referred to as a captured image). Also, the recognition unit 130 may recognize a travel lane by recognizing a traveling path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. Also, for example, the recognition unit 130 recognizes a temporary stop line, red traffic light, a toll gate, an entrance/exit gate of a parking lot, a stopping area, a getting-into/out area, and other road events.

When the travel lane is recognized, the recognition unit 130 recognizes a position or orientation of the host vehicle M with respect to the travel lane or a parking space. For example, the recognition unit 130 may recognize a gap of a reference point of the host vehicle M from the center of the lane and an angle formed with respect to a line connecting the center of the lane in the travel direction of the host vehicle M as a relative position and orientation of the host vehicle M related to the travel lane. Alternatively, the recognition unit 130 may recognize a position of the reference point of the host vehicle M related to one side end portion (a road dividing line or a road boundary) of the travel lane or the like as a relative position of the host vehicle M related to the travel lane.

For example, the recognition unit 130 includes a parking space recognition unit 132, a traveling route recognition unit 134, and a communication situation recognition unit 136. Details of the functions of the parking space recognition unit 132, the traveling route recognition unit 134, and the communication situation recognition unit 136 will be described below.

The action plan generation unit 140 generates an action plan for causing the host vehicle M to travel according to automated driving. For example, the action plan generation unit 140 generates a future target trajectory along which the host vehicle M automatedly travels (independently of an operation of the driver) so that the host vehicle M can generally travel in the recommended lane determined by the recommended lane determination unit 61 and further cope with a surrounding situation of the host vehicle M on the basis of a recognition result of the recognition unit 130 or the like. For example, the target trajectory includes a speed element. For example, the target trajectory is represented by sequentially arranging points (trajectory points) at which the host vehicle M is required to arrive. The trajectory point is a point where the host vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the host vehicle M is required to arrive at the sampling time for each predetermined sampling time. In this case, information about the target speed or the target acceleration is represented by an interval between the trajectory points.

The action plan generation unit 140 may set an automated driving event when the target trajectory is generated. Automated driving events include a constant-speed traveling event, a low-speed following traveling event, a lane change event, a branching event, a merging event, a takeover event, an autonomous parking event in which a vehicle is parked according to automated driving in the parking lot of valet parking or the like, and the like. The action plan generation unit 140 generates a target trajectory according to an activated event. For example, the action plan generation unit 140 includes an autonomous parking control unit 142 activated when the autonomous parking event is executed. Details of a function of the autonomous parking control unit 142 will be described below.

The second control unit 160 controls the travel driving force output device 200, the brake device 210, and the steering device 220 so that the host vehicle M passes along the target trajectory generated by the action plan generation unit 140 at a scheduled time.

The second control unit 160 includes, for example, an acquisition unit 162, a speed control unit 164, and a steering control unit 166. The acquisition unit 162 acquires information of a target trajectory (trajectory points) generated by the action plan generation unit 140 and causes the acquired information to be stored in a memory (not shown). The speed control unit 164 controls the travel driving force output device 200 or the brake device 210 on the basis of speed elements associated with the target trajectory stored in the memory. The steering control unit 166 controls the steering device 220 in accordance with a level of curve of a target trajectory stored in the memory. For example, processes of the speed control unit 164 and the steering control unit 166 are implemented by a combination of feed-forward control and feedback control. As one example, the steering control unit 166 executes feed-forward control according to the curvature of the road in front of the host vehicle M and feedback control based on a deviation from the target trajectory in combination.

Returning to FIG. 2, the HMI control unit 180 notifies the occupant of predetermined information by means of the HMI 30. The predetermined information may include information related to traveling of the host vehicle M such as information about the state of the host vehicle M and information about driving control. The information about the state of the host vehicle M includes, for example, a speed of the host vehicle M, an engine speed, a shift position, and the like. Also, the information about the driving control includes, for example, information about whether or not automated driving is to be executed, information about presetting for starting automated driving, information for asking about whether or not to start automated driving, information about a degree of driving assistance based on automated driving, and the like. Also, the predetermined information may include information that is not related to the traveling of the host vehicle M, such as content (for example, a movie) stored in a storage medium such as a TV program or a DVD. Also, the predetermined information may include, for example, information about a communication state between the host vehicle M and the terminal device 300, a current position and a destination in automated driving, and the remaining amount of fuel of the host vehicle M. The HMI control unit 180 may output information received by the HMI 30 to the communication device 20, the navigation device 50, the first control unit 120, and the like.

Also, the HMI control unit 180 may communicate with the terminal device 300 stored in the terminal information 192 or the parking lot management device 500 via the communication device 20 and transmit predetermined information to the terminal device 300 or the parking lot management device 500. Also, the HMI control unit 180 may cause the HMI 30 to output information acquired from the terminal device 300 or the parking lot management device 500. For example, when the communication device 20 has received an inquiry from the terminal device 300 or the parking lot management device 500, the HMI control unit 180 may generate a response to the inquiry by the automated driving control device 100 and cause the generated response to be transmitted to the terminal device 300 or the parking lot management device 500 sending the inquiry.

Also, for example, the HMI control unit 180 may perform control for causing the display device of the HMI 30 to display a registration screen for registering the terminal device 300 that communicates with the host vehicle M and causing information about the terminal device 300 input via the registration screen to be stored in the storage unit 190 as terminal information 192. The above-described registration of the terminal information 192 is executed, for example, at a predetermined timing when the user U gets into the vehicle or before the automated driving such as the autonomous parking event is started. Also, the above-described registration of the terminal information 192 may be executed by an application program (a parking application to be described below) installed in the terminal device 300.

The travel driving force output device 200 outputs a travel driving force (torque) for driving the vehicle to the drive wheels. The travel driving force output device 200 includes, for example, a combination of an internal combustion engine, an electric motor, a transmission, and the like, and an electronic control unit (ECU) that controls these components. The ECU controls the above-described components in accordance with information input from the second control unit 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second control unit 160 or the information input from the driving operation element 80 so that brake torque according to a braking operation is output to each wheel. The brake device 210 may include a mechanism configured to transfer the hydraulic pressure generated by an operation of the brake pedal included in the driving operation element 80 to the cylinder via a master cylinder as a backup. Also, the brake device 210 is not limited to the above-described configuration and may be an electronically controlled hydraulic brake device configured to control the actuator in accordance with information input from the second control unit 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor to change the direction of the steerable wheels in accordance with the information input from the second control unit 160 or the information input from the driving operation element 80.

### [Terminal Device]

FIG. 4 is a diagram showing an example of a functional configuration of the terminal device 300. The terminal device 300 includes, for example, a communication unit 310, an input unit 320, a display 330, a speaker 340, an application execution unit 350, an output control unit 360, and a storage unit 370. The communication unit 310, the input unit 320, the application execution unit 350, and the output control unit 360 are implemented, for example, by a hardware processor such as a CPU executing a program (software). Some or all of these components are implemented, for example, by hardware (a circuit including circuitry) such as LSI, an ASIC, an FPGA, or a GPU or may be implemented by software and hardware in cooperation. The above-described program may be pre-stored in a storage device (a storage device including a non-transitory storage medium) such as an HDD or a flash memory of the terminal device 300 or may be stored in a removable storage medium such as a DVD, a CD-ROM, or a memory card and installed in the storage device of the terminal device 300 when the storage medium (the non-transitory storage medium) is mounted in a drive device, a card slot, or the like.

The storage unit 370 is implemented by the various types of storage devices described above. Also, the storage unit 370 is implemented by, for example, an HDD, a flash memory, an EEPROM, a ROM, a RAM, or the like. The storage unit 370 stores, for example, a parking application 372, a program, and other various types of information. The parking application 372 is an example of a “vehicle control application”.

The communication unit 310 communicates with other devices using, for example, a cellular network, a Wi-Fi network, a network such as Bluetooth, a LAN, a WAN, or the Internet.

For example, the input unit 320 receives the input from a user by operating various types of keys and buttons and the like. The display 330 is, for example, a liquid crystal display (LCD) or the like. The input unit 320 may be configured integrally with the display 330 as a touch panel. The display 330 displays information about automated driving in the embodiment and other information necessary for using the terminal device 300 according to the control of the output control unit 360. For example, the speaker 340 outputs a predetermined sound according to the control of the output control unit 360.

The application execution unit 350 is implemented by the processor executing the parking application 372 stored in the storage unit 370. For example, the parking application 372 is an application program (an application) for communicating with the host vehicle M or the parking lot management device 500 of the destination facility to be visited via a network and transmitting an automated entering request, an automated leaving request, or the like according to automated driving to the parking lot management device 500 or the host vehicle M.

Also, the application execution unit 350 may recognize a state of communication with the parking lot management device 500 or the host vehicle M and switch a target to which an entering instruction or a leaving instruction is transmitted in accordance with a recognition result. In this case, the application execution unit 350 receives a specific signal (for example, a heartbeat signal) transmitted from the host vehicle M or the parking lot management device 500 at predetermined time intervals or transmits an inquiry signal for inquiring about an operation and recognizes the communication state of the communication device 20 of the host vehicle M or the parking lot management device 500 on the basis of a reception state of a response signal or details of the signal. For example, when the specific signal has been received at predetermined time intervals or when the response signal has been received (when the response signal has been successfully received), the application execution unit 350 determines that a state of communication with a device that has transmitted the specific signal or the response signal is normal. Also, for example, when no specific signal can be received at predetermined time intervals, or when no response signal has been received within a predetermined period, the application execution unit 350 determines that a communication state of a device that has not transmitted the specific signal or the response signal is not normal (that the communication state is abnormal or that communication has failed). Also, when the above-described recognized normal or abnormal state has continued for a predetermined time period or more, the application execution unit 350 may finally recognize that the communication state is normal or abnormal. Thereby, for example, the application execution unit 350 transmits an automated entering request or an automated leaving request to the parking lot management device 500 when the state of communication with the parking lot management device 500 is normal and transmits an automated entering instruction, an automated leaving instruction, or the like by switching a transmission destination to the host vehicle M when the state of communication with the parking lot management device 500 is abnormal and the state of communication with the host vehicle M is normal. The switching of the transmission destination by the application execution unit 350 described above may be performed in response to a request from the parking lot management device 500 via the host vehicle M.

Also, the application execution unit 350 acquires information transmitted by the parking lot management device 500 or the host vehicle M and causes the output control unit 360 to execute a predetermined notification on the basis of the acquired information. The predetermined notification is, for example, the image display on the display 330 and the sound output from the speaker 340. For example, the application execution unit 350 may make notification details to be output different between a case in which an object that requests automated entering or automated leaving is the parking lot management device 500 and a case in which communication with the parking lot management device 500 is impossible and switching to the host vehicle M is performed.

Also, the application execution unit 350 may transmit position information of the terminal device 300 acquired by a global positioning system (GPS) device (not shown) built in the terminal device 300 to the parking lot management device 500 or the host vehicle M, register the terminal information, the notification details, and the like, or perform other processes related to vehicle cooperation.

The output control unit 360 controls details or a display mode of an image to be displayed on the display 330 and details or an output mode of a sound to be output to the speaker 340 according to an instruction of the application execution unit 350. For example, the output control unit 360 may cause the display 330 to display information about driving control (automated entering and automated leaving) from the host vehicle M, information for inquiring about an instruction of the driving control and the locking state, and the like or cause the speaker 340 to output a sound corresponding to the above-described information. Also, the output control unit 360 may acquire an image or a sound of the notification details from an external device or generate an image or a sound within the terminal device 300 to cause the image and the sound to be output from the display 330 and the speaker 340. The output control unit 360 may cause various types of information necessary for using the terminal device 300 to be output from the display 330 and the speaker 340.

### [Driving Control Based on Automated Driving]

Next, the driving control based on the automated driving according to the embodiment will be specifically described. Hereinafter, an example of the driving control in the traveling based on the automated driving of the host vehicle M will be described using a scene in which autonomous parking is performed in traveling based on the automated driving in valet parking of a destination facility to be visited that is an example of an area including a parking lot. In the following, parking in “unmanned traveling” in which traveling is performed in an “unmanned manner” is assumed to be used as an example of “autonomous parking”. The automated driving in the present embodiment may be performed in a state in which the occupant is in the vehicle.

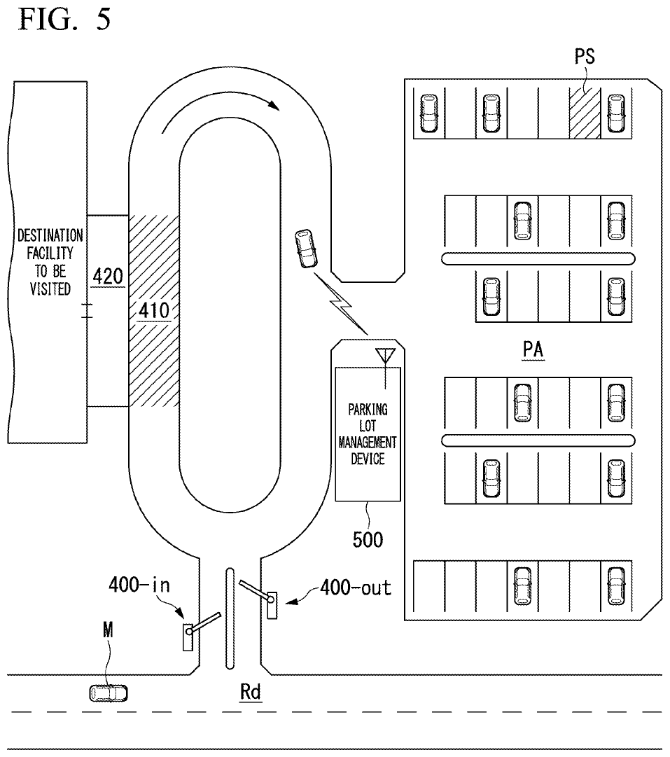

FIG. 5 is a diagram schematically showing a scene in which an autonomous parking event is executed in the embodiment. In the example of FIG. 5, a parking lot (for example, valet parking) PA of the destination facility to be visited is shown. In the parking lot PA, gates 400-in and 400-out, a stopping area 410, and a getting-into/out area 420 are assumed to be provided along a route from a road Rd to the destination facility to be visited. Also, in the example of FIG. 5, the parking lot management device 500 for controlling a parking situation of the parking lot PA or the entering or leaving of the vehicle is assumed to be provided.

Here, processes at the time of automated entering and automated leaving of the host vehicle M due to the autonomous parking event will be described. Different processes are executed at the time of automated entering and automated leaving on the basis of communication states of the terminal device 300, the host vehicle M, and the parking lot management device 500. When the communication state is determined, the host vehicle M determines whether or not the communication state is normal by recognizing a state of communication with the terminal device 300 or the parking lot management device 500 on the basis of a specific signal or a response signal in the communication situation recognition unit 136 as in the above-described process of the application execution unit 350. Also, the parking lot management device 500 determines whether or not a state of communication with the terminal device 300 or the host vehicle M is normal on the basis of the specific signal and the response signal in the communication state management unit 522 to be described below as in the process of the application execution unit 350. Hereinafter, driving control of autonomous parking according to the communication states of the terminal device 300, the host vehicle M, and the parking lot management device 500 will be described for each of several control patterns. Also, each control pattern including the operations of the terminal device 300 and the parking lot management device 500 will be described.

### [First Control Pattern]

In a first control pattern, automated entering and automated leaving when all communication states of the terminal device 300, the host vehicle M, and the parking lot management device 500 are normal will be described. When all the communication states are normal, an automated entering request and an automated leaving request are transmitted from the terminal device 300 to the parking lot management device 500, a route to the parking space PS is indicated from the parking lot management device 500 to the host vehicle M and the host vehicle M executes the automated entering and the automated leaving along the route indicated from the parking lot management device 500 (hereinafter referred to as an instruction route). Also, execution conditions of the automated entering and the automated leaving of the host vehicle M are not limited to the above-described conditions and may be executed, for example, when a preset time period has elapsed or when other execution conditions are satisfied.

### [Automated Entering]

First, the automated entering in the first control pattern will be described. The host vehicle M moves to the stopping area 410 through the gate 400-in shown in FIG. 5 according to manual driving or automated driving. The stopping area 410 faces the getting-into/out area 420 connected to the destination facility to be visited. Eaves for avoiding rain and snow are provided in the getting-into/out area 420. After the occupant (hereinafter referred to as the user U) gets out of the stopping area 410, the host vehicle M performs unmanned automated driving and starts an autonomous parking event in which the host vehicle M moves to the parking space PS within the parking lot PA.

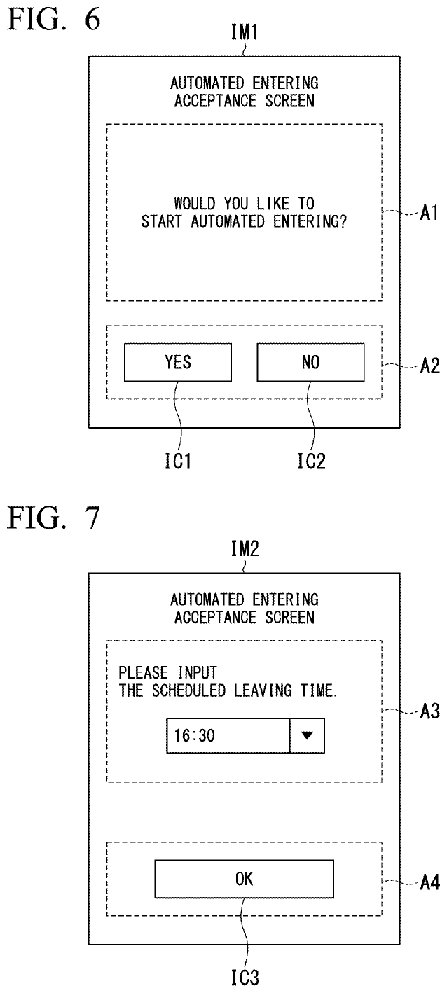

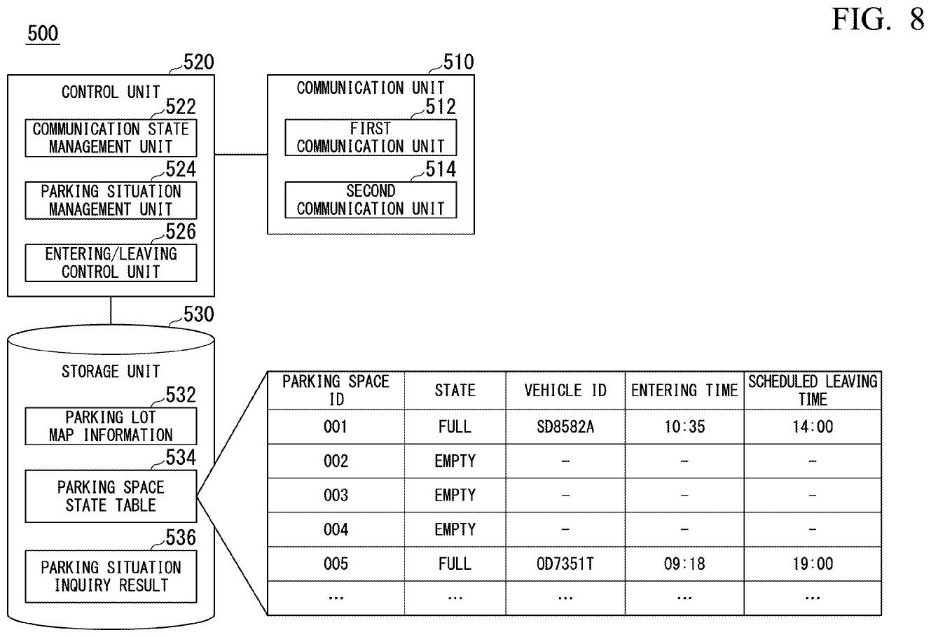

Also, before the execution of the autonomous parking event (the automated entering), the terminal device 300 first displays an automated entering acceptance screen for inquiring the user U about whether to perform the automated entering. FIG. 6 is a diagram showing an example of an image IM1 displayed on the display 330 of the terminal device 300 as the automated entering acceptance screen. The image IM1 shown in FIG. 6 is generated by, for example, the output control unit 360. Also, an image layout and displayed details are not limited to the images shown in FIG. 6. The same applies to the description of images of FIG. 7 and subsequent drawings.

For example, the output control unit 360 causes the image IM1 shown in FIG. 6 to be displayed according to a display instruction of the user U or causes the image IM1 shown in FIG. 6 to be displayed at a predetermined timing after it is estimated that the host vehicle M is stopped in the stopping area 410 or the user U gets out of the host vehicle M. For example, the determination as to whether or not the user U has gotten out of the host vehicle M is made according to whether or not the recognition unit 130 has recognized the user U from facial feature information or the like according to an analysis result of the image captured by the camera 10 or is made according to whether or not a load on a seat detected by the load sensor of the vehicle sensor 40 is less than or equal to a threshold value. The recognition unit 130 transmits an instruction for causing the terminal device 300 to display an automated entering acceptance screen via the communication device 20 when the user U has been recognized according to an analysis result of the image captured by the camera 10 on the basis of a result of recognition via the communication device 20 or when the load on the seat detected by the load sensor is less than or equal to the threshold value. The output control unit 360 of the terminal device 300 causes the display 330 to display the image IM1 shown in FIG. 6 on the basis of the above-described instruction.

In the example of FIG. 6, the image IM1 includes a text information display area A1 and a selection item display area A2 as the automated entering acceptance screen. In the text information display area A1, for example, text information for inquiring the user U about whether or not to start automated entering is displayed. In the example of FIG. 6, text information such as “Would you like to start automated entering?” is displayed in the text information display area A1.

The selection item display area A2 includes a graphical user interface (GUI) icon IC1 (a YES button) for accepting approval of displayed details in the text information display area A1 and a GUI icon IC2 (a NO button) for accepting rejection of the displayed details.

Also, the output control unit 360 may cause a sound corresponding to the text information displayed in the text information display area A1 to be output from the speaker 340 in addition to (or instead of) displaying the image IM1 described above. The same applies to the description of subsequent images.

When the operation of the GUI icon IC1 has been received by the input unit 320, the output control unit 360 generates an image IM2 for inputting the scheduled leaving time and causes the display 330 to output the generated image IM2. FIG. 7 is a diagram showing an example of the image IM2 for inputting the scheduled leaving time. The image IM2 includes a time input area A3 and a selection item display area A4. In the time input area A3, for example, text information for prompting the user U to input the scheduled leaving time and a GUI widget for inputting the scheduled leaving time are displayed. In the example of FIG. 7, text information such as “Please input the scheduled leaving time” and a combo box in which a time can be input by selecting one of a plurality of times displayed in a drop-down list or by directly inputting a number using the input unit 320 are displayed in the time input area A3.

The selection item display area A4 includes a GUI icon IC3 (an OK button) for accepting approval of input details in the time input area A3. When the input unit 320 has received the operation of the GUI icon IC3 by the user U, the output control unit 360 causes the display of the image IM2 to end. Information about the automated entering request and the scheduled leaving time is transmitted to the parking lot management device 500 together with information about an entering target vehicle (for example, a vehicle ID). Also, when the GUI icon IC2 has been selected in the image IM1 shown in FIG. 6, the output control unit 360 ends the display of the image IM1.

The parking lot management device 500 communicates with the host vehicle M on the basis of the information about the automated entering request and the scheduled leaving time transmitted from the terminal device 300 and causes the host vehicle M to travel in a predetermined parking space PS.

For example, the autonomous parking control unit 142 of the host vehicle M causes the host vehicle M to park within the parking space PS of the parking lot PA on the basis of information acquired from the parking lot management device 500 by the communication device 20. Specifically, when the autonomous parking event is started, the autonomous parking control unit 142 controls the communication device 20 so that the communication device 20 receives an automated entering instruction from the parking lot management device 500. The host vehicle M moves from the stopping area 410 to the parking lot PA in accordance with the guidance of the parking lot management device 500 or while performing sensing on its own.

Also, the image IM1 shown in FIG. 6 and the image IM2 shown in FIG. 7 may be displayed on the HMI 30 of the host vehicle M when the display is ready before the occupant gets out of the host vehicle M.

FIG. 8 is a diagram showing an example of a configuration of the parking lot management device 500. The parking lot management device 500 includes, for example, a communication unit 510, a control unit 520, and a storage unit 530. The control unit 520 includes, for example, a communication state management unit 522, a parking situation management unit 524, and an entering/leaving control unit 526. The communication unit 510 and the control unit 520 are implemented by, for example, a hardware processor such as a CPU executing a program (software). Some or all of these components are implemented, for example, by hardware (a circuit including circuitry) such as LSI, an ASIC, an FPGA, or a GPU or may be implemented by software and hardware in cooperation. The above-described program may be pre-stored in a storage device (a storage device including a non-transitory storage medium) such as an HDD or a flash memory of the parking lot management device 500 or may be stored in a removable storage medium such as a DVD, a CD-ROM, or a memory card and installed in the storage device of the terminal device 300 when the storage medium (the non-transitory storage medium) is mounted in a drive device, a card slot, or the like.

The storage unit 530 is implemented by the various types of storage devices described above. The storage unit 530 is implemented by, for example, an HDD, a flash memory, an EEPROM, a ROM, a RAM, or the like. The storage unit 530 stores, for example, parking lot map information 532, a parking space state table 534, programs, and other various types of information.

The communication unit 510 wirelessly communicates with the host vehicle M, other vehicles, the terminal device 300, and the like on the basis of the communication state of the communication state management unit 522. The communication unit 510 includes, for example, a first communication unit 512 and a second communication unit 514. The first communication unit 512 communicates with the host vehicle M within the parking lot PA. The second communication unit 514 communicates with the terminal device 300 used by the user U of the host vehicle M.

The control unit 520 integrates a result of communication of the first communication unit 512 with the host vehicle M and a result of communication of the second communication unit 514 with the terminal device 300 and controls a parking lot use state of the host vehicle M. When the communication state management unit 522 to be described below determines that the communication of the second communication unit 514 is not normal, the control unit 520 causes the first communication unit 512 to acquire a result of direct communication between the terminal device 300 and the host vehicle M via the host vehicle M. Also, the direct communication means that “the parking lot management device 500 is not involved” and does not exclude that an access point, a network, or the like is interposed between the terminal device 300 and the host vehicle M.

The communication state management unit 522 determines whether or not the communication state between the second communication unit 514 and an external device (the terminal device 300 or the host vehicle M) is normal on the basis of the specific signal and the response signal. For example, the communication state management unit 522 determines that the communication state is not normal when the second communication unit 514 cannot communicate with another device and the communication fails (a communication error occurs). The above-described communication error is not limited to a malfunction of the second communication unit 514 and may be caused by a malfunction of some of the components of the parking lot management device 500, a malfunction of the network between the terminal device 300 and the second communication unit 514, or the like. Also, the communication state management unit 522 recognizes that the communication state has been changed (restored) from an abnormal state to a normal state. The parking situation management unit 524 guides the vehicle to the parking space PS on the basis of the information acquired by the communication unit 510 and the information stored in the storage unit 530.

The parking lot map information 532 is information geometrically representing the structure of the parking lot PA. The parking lot map information 532 includes coordinates for each parking space PS. In the parking space state table 534, for example, a state which is an empty state or a full (parked) state, a vehicle ID which is identification information of a parked vehicle in the case of the full state, an entering time at which the vehicle enters the parking space PS, and a scheduled leaving time at which the vehicle leaves the parking space PS are associated with a parking space ID which is identification information of the parking space PS. The entering time is the time when the host vehicle M parked in the parking space PS. Also, the entering time may be the time when the host vehicle M passed through the gate 400-in or the time when automated entering started from a point P1 where the vehicle stopped in the stopping area 410. The scheduled leaving time is, for example, the time specified by the user U using the terminal device 300. The entering time and the scheduled leaving time may be stored in the storage unit 190 of the host vehicle M. The parking space state table 534 is an example of “parking lot use state information”.

When the entering instruction (the automated entering request) of the host vehicle M is received from the terminal device 300 of the user U, the parking situation management unit 524 extracts a parking space PS whose state is empty with reference to the parking space state table 534, acquires a position of the extracted parking space PS from the parking lot map information 532, and transmits a preferable route to the acquired position of the parking space PS to the host vehicle M using the communication unit 510. Also, the parking situation management unit 524 instructs a specific vehicle to stop or slow down, as necessary, on the basis of a positional relationship of a plurality of vehicles present within the parking lot PA so that the vehicles do not move to the same position at the same time.

The autonomous parking control unit 142 of the host vehicle M that has received the instruction route (hereinafter referred to as an entering instruction route) from the parking lot management device 500 generates a target trajectory based on the entering instruction route as an automated entering process. Also, when the host vehicle M approaches the target parking space PS, the parking space recognition unit 132 recognizes parking slot lines that partition the parking space PS and the like, recognizes a detailed position of the parking space PS, and provides the recognized position to the autonomous parking control unit 142. The autonomous parking control unit 142 receives the provided position to correct the target trajectory and cause the host vehicle M to be parked in the parking space PS.

The autonomous parking control unit 142 may find an empty parking space on its own on the basis of a detection result of the camera 10, the radar device 12, the finder 14, or the physical object recognition device 16 independently of communication and cause the host vehicle M to be parked within the found parking space without being limited to the above description.

The parking situation management unit 524 sets information indicating that the vehicle is in a full state (for example, “full” shown in FIG. 8) in the “state” of the parking space state table 534 associated with the parking space ID of the parking space PS where the host vehicle M is parked and stores the vehicle ID, the entering time, and the scheduled leaving time of the host vehicle M.

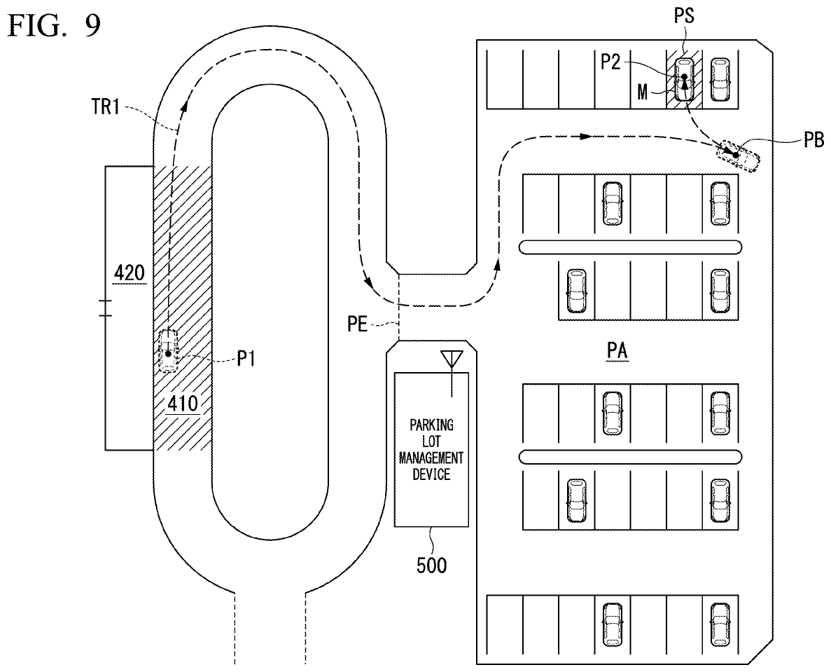

The traveling route recognition unit 134 recognizes, for example, a traveling route until the host vehicle M is parked in the parking space PS from a point where the host vehicle M has started automated entering. FIG. 9 is a diagram for describing the traveling route recognition unit 134. FIG. 9 shows an extracted part of the parking lot PA of the destination facility to be visited shown in FIG. 5 described above. The traveling route recognition unit 134 sets a point where the entering instruction route has been received from the parking lot management device 500 (a stop point in the stopping area 410 where the user U has gotten out of the host vehicle M in the getting-into/out area 420 in the example of FIG. 9) as a start point P1 and recognizes a traveling route TR1 to a point where the host vehicle M is parked in the parking space PS (hereinafter referred to as an end point P2) after actual traveling along the entering instruction route. The traveling route TR1 includes, for example, a point through which a reference point of the host vehicle M (for example, the center or the center of gravity of the host vehicle

M) passes on the road. Also, the traveling route recognition unit 134 may use a predetermined point within the stopping area 410 or an entrance point of the parking lot PA (a point PE shown in FIG. 9) instead of the start point P1. Also, the traveling route recognition unit 134 may recognize the traveling route at the time of entering according to manual driving of the user U, for example, instead of the traveling route based on the entering instruction route from the parking lot management device 500.

Also, the traveling route recognition unit 134 may recognize information about the behavior of the host vehicle M at the time of entering. The information about the behavior is, for example, information about a speed of the host vehicle M at the time of entering and a vehicle direction (for example, forward movement, backward movement, or a steering angle) with respect to a traveling direction. For example, the traveling route recognition unit 134 recognizes that the host vehicle M travels forward from the start point P1 to a point PB and travels backward (performs back traveling) from the point PB to the end point P2 in the entire traveling route TR1. The traveling route recognition unit 134 causes the storage unit 190 to store information including information about the traveling route TR1 and the behavior as the entry traveling route information 194.

### [Automated Leaving]

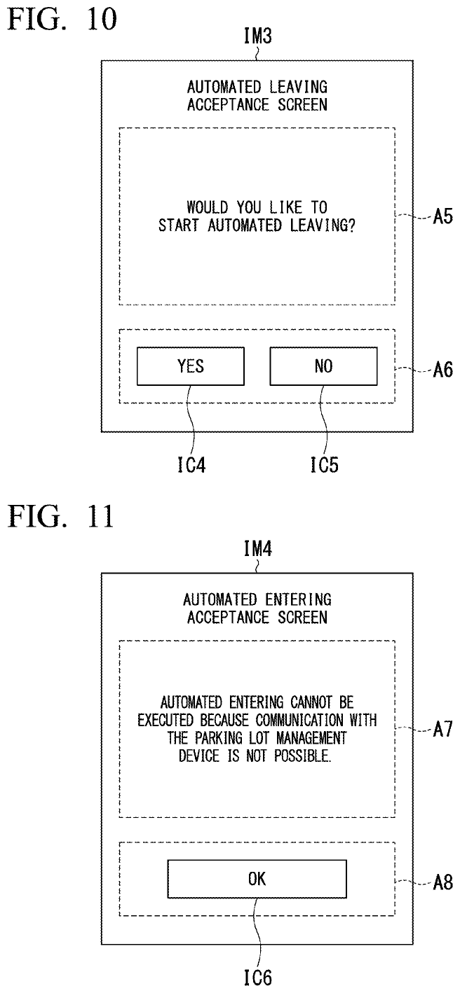

Next, automated leaving in the first control pattern will be described. It is assumed that the autonomous parking control unit 142 and the communication device 20 maintain the operating state even if the host vehicle M is parked. Before the execution of the autonomous parking event (automated leaving), the terminal device 300 first displays an automated leaving acceptance screen for inquiring the user U about whether or not to perform the automated leaving. FIG. 10 is a diagram showing an example of an image IM3 displayed on the display 330 of the terminal device 300 as an automated leaving acceptance screen. For example, the output control unit 360 may cause the image IM3 shown in FIG. 10 to be displayed according to a display instruction of the user U or to be displayed at the timing when an inquiry from the parking lot management device 500 is made when the current time has reached the scheduled leaving time.

In the example of FIG. 10, the image IM3 includes a text information display area A5 and a selection item display area A6 as the automated leaving acceptance screen. In the text information display area AS, for example, text information for inquiring the user U about whether or not to start automated leaving is displayed. In the example of FIG. 10, displays text information such as “Would you like to start automated leaving?” is displayed in the text information display area A5.

The selection item display area A6 includes a GUI icon IC4 (a YES button) for accepting approval of displayed details in the text information display area A5 and a GUI icon IC5 (a NO button) for accepting rejection of the displayed details.

When the operation of the GUI icon IC4 has been received by the input unit 320, the output control unit 360 transmits an automated leaving request for executing automated leaving to the parking lot management device 500 together with information about a leaving target vehicle (for example, a vehicle ID) and ends the display of the image IM3. Also, when the operation of the GUI icon IC5 has been received by the input unit 320, the output control unit 360 ends the display of the image IM3.

When the automated leaving request transmitted by the terminal device 300 has been received, the parking situation management unit 524 of the parking lot management device 500 communicates with the host vehicle M and outputs a leaving instruction route for causing the host vehicle M to leave a predetermined parking space PS (for example, a route from the parking space PS to the stopping area 410).

For example, the autonomous parking control unit 142 causes the system of the host vehicle M to be activated on the basis of the automated leaving instruction received from the parking lot management device 500 by the communication device 20 and executes the automated leaving. Also, the autonomous parking control unit 142 receives the leaving instruction route from the parking lot management device 500 and causes the host vehicle M to move to the stopping area 410 on the basis of the received leaving instruction route. At this time, the autonomous parking control unit 142 controls the communication device 20 so that the communication device 20 transmits position information of the host vehicle M to the parking lot management device 500. The control unit 520 of the parking lot management device 500 instructs a specific vehicle to stop or slow down, as necessary, on the basis of a positional relationship of a plurality of vehicles so that the vehicles do not move to the same position at the same time on the basis of the position information of the host vehicle M as in the entering process.

Also, the autonomous parking control unit 142 determines whether or not the user U is present in a getting-into/out area (a getting-into area when the getting-into area and a getting-out area are separated) 420 and causes the host vehicle M to stop in the empty space of the stopping area 410 within a predetermined distance from a position where the user U is present when it is determined that the user U is present. In this case, the autonomous parking control unit 142 acquires the position information from the terminal device 300 and determines that the user U is present in the getting-into/out area 420 when the acquired position information is within the getting-into/out area 420. Also, the autonomous parking control unit 142 may determine whether or not the user U is present in the getting-into/out area 420 on the basis of a detection result of the camera 10, the radar device 12, the finder 14, or the physical object recognition device 16. In this case, the autonomous parking control unit 142 acquires feature information of the user U from the detection result of the camera 10, the radar device 12, the finder 14, or the physical object recognition device 16 in advance before the host vehicle M performs an entering process. The autonomous parking control unit 142 compares feature information of a person obtained from the detection result at the time of leaving with feature information of the user U and determines that the user U is present when a degree of similarity is greater than or equal to a predetermined value.

After the user U is allowed to get into the vehicle after stopping, an operation of the autonomous parking control unit 142 is stopped and the manual driving or the automated driving by another functional unit is subsequently started. In this case, for example, the autonomous parking control unit 142 determines that the user U is in the host vehicle M when the opening or closing of the door of the host vehicle M is detected, when an operation on the driving operation element 80 or the HMI 30 is received, or when the load on the vehicle interior seat is greater than or equal to a predetermined value.

Also, the autonomous parking control unit 142 may delete entry traveling route information 194 stored in the storage unit 190 when the automated leaving based on the instruction from the parking lot management device 500 has been completed. Also, when the automated leaving of the host vehicle M has been completed, the parking situation management unit 524 may set “empty” indicating an empty state in an item of the “state” associated with the parking space ID of the parking space PS where the host vehicle M has parked in the parking space state table 534 and may delete a vehicle ID, an entering time, and a scheduled leaving time of the host vehicle M or maintain the storage thereof for a predetermined period (for example, about 1 [day]).

Also, although a process for the host vehicle M has been mainly described in the first control pattern, the parking lot management device 500 performs a similar process for other vehicles within the destination facility to be visited and executes control related to entering or leaving. The same applies to the description of the subsequent control patterns.

### [Second Control Pattern]

In a second control pattern, automated entering and automated leaving when some devices of the terminal device 300, the host vehicle M, and the parking lot management device 500 (for example, the parking lot management device 500) are not normal will be described. That is, the second control pattern is associated with a malfunction of the communication unit 510 of the parking lot management device 500 and a case in which the information stored in the storage unit 530 can be referred to and updated will be described. Also, in the following, differences from the first control pattern will be mainly described and the description of common parts will be omitted.

### [Automated Entering]

In the second control pattern, the terminal device 300 first causes the display 330 to display the image IM1 shown in FIG. 6 described above. When the operation of the GUI icon IC1 by the user U has been received, the input unit 320 transmits an automated entering request to the parking lot management device 500. However, no automated entering cannot be executed because the communication state of the parking lot management device 500 is not normal in the second control pattern. Thus, the output control unit 360 causes the display 330 to display information indicating that the automated entering process cannot be executed.

FIG. 11 is a diagram showing an example of an image IM4 indicating that the automated entering process cannot be executed. In the example of FIG. 11, the image IM4 includes a text information display area A7 and a selection item display area A8. In the text information display area A7, for example, information indicating that automated entering cannot be executed and information indicating the reason why automated entering cannot be executed are displayed. In the example of FIG. 11, text information such as “Automated entering cannot be executed because communication with the parking lot management device is not possible” is displayed in the text information display area A7.

The selection item display area A8 includes a GUI icon IC6 (an OK button) for accepting approval of displayed details in the text information display area A7. When the input unit 320 has received the operation of the GUI icon IC6 by the user U, the output control unit 360 causes the display of the image IM4 to end. Thereby, the user U is allowed to ascertain that automated entering cannot be executed and the reason why automated entering cannot be executed. As a result, the user U can take a measure such as parking in a method other than automatic entering (for example, manual driving) or make an automated entering request again after the lapse of a predetermined time period because there is a possibility of the communication state of the parking lot management device 500 being restored.

Also, in the second control pattern, a state of communication with the parking lot management device 500 may not be normal after the automated entering instruction is received from the parking lot management device 500 and at a timing before the reception of the entering instruction route or a timing before the start of traveling along the entering instruction route. In this case, the autonomous parking control unit 142 may perform control for curbing automated entering. Also, control for transmitting information indicating that the communication state of the parking lot management device 500 is not normal to the terminal device 300 may be performed.

In this case, a function in which the parking lot management device 500 relays the communication result to the host vehicle M and the terminal device 300 to implement automated entering and automated leaving (hereinafter referred to as a relay function) as in the first control pattern described above is transferred from the terminal device 300 or the parking lot management device 500 to the host vehicle M. The communication device 20 of the host vehicle M transmits information generated by the relay function such as a recognition result of the recognition unit 130, a processing result of the action plan generation unit 140, and a result of communication with the terminal device 300 to the parking lot management device 500 and causes the information to be stored and accumulated in the storage unit 530. Also, the communication device 20 may transmit the processing results accumulated in the storage unit 530 to an information acquisition source.

Also, even when the communication between the parking lot management device 500 and the terminal device 300 is normal, the parking lot management device 500 may communicate with the terminal device 300, acquire information from the parking application 372, and accumulate the information in the storage unit 370 or a storage unit (not shown) of the automated driving control device 100.

### [Automated Leaving]

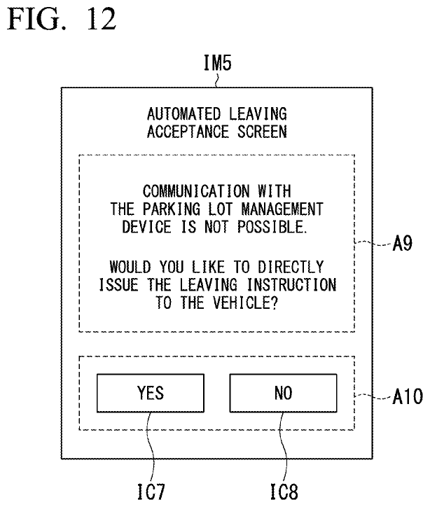

In the second control pattern, when a state of communication with the parking lot management device 500 is not normal at the time of leaving, the output control unit 360 generates an image for inquiring about whether or not to directly issue a leaving instruction to the host vehicle M and causes the display 330 to display the generated image. FIG. 12 is a diagram showing an example of an image IM5 for inquiring about whether or not to directly issue a leaving instruction to the host vehicle M. In the example of FIG. 12, the image IM5 includes a text information display area A9 and a selection item display area A10. In the text information display area A9, for example, information indicating that communication with the parking lot management device is not possible and information for inquiring about whether or not to directly issue an automated leaving request to the host vehicle M instead of the parking lot management device 500 are displayed. In the example of FIG. 12, text information such as “Communication with the parking lot management device is not possible. Would you like to directly issue the leaving instruction to the vehicle?” is displayed in the text information display area A9.

The selection item display area A10 includes a GUI icon IC7 (a YES button) for accepting approval of displayed details in the selection item display area A8 and a GUI icon IC8 (a NO button) for accepting rejection of displayed details in the selection item display area A8. When the input unit 320 has received the operation of the GUI icon IC7 by the user U, the output control unit 360 transmits an automated leaving instruction to the host vehicle M and causes the display of the image IM5 to end. Also, when the input unit 320 has received the operation of the GUI icon IC8 by the user U, the output control unit 360 causes the display of the image IM5 to end.

Because the leaving instruction route cannot be received from the parking lot management device 500 when the automated leaving instruction has been received from the terminal device 300, the autonomous parking control unit 142 executes the automated leaving for causing the host vehicle M to leave using the entry traveling route information 194 stored in the storage unit 190. Specifically, the autonomous parking control unit 142 generates a scheduled traveling route for causing the host vehicle M to travel so that an area of at least a part of the traveling route TR1 from the point P2 to the point P1 is reversely reproduced by setting the end point P2 of the traveling route TR1 included in the entry traveling route information 194 as a start point at the time of leaving and setting the start point P1 as an end point at the time of leaving. Reverse reproduction includes, for example, leaving along the traveling route at the time of entering. Also, the reverse regeneration may include performing the behavior at the time of leaving on the basis of the behavior of the host vehicle M at the time of entering (for example, the speed at the time of entering). Then, the autonomous parking control unit 142 causes the host vehicle M to move to the stopping area 410 by causing the host vehicle M to travel on the basis of a target trajectory based on the generated scheduled traveling route.

Also, if the traveling of the host vehicle M at the time of entering is simply reversely reproduced, the host vehicle M is allowed to travel while moving backward. Accordingly, the autonomous parking control unit 142 may generate a scheduled traveling route for causing the host vehicle M to leave in a direction opposite to the direction of the host vehicle M at the time of entering so that traveling of the reverse reproduction is enabled while the host vehicle M moves forward at the time of leaving.

### [Third Control Pattern]

In a third control pattern, automated entering and automated leaving when a failure particularly occurs in the parking lot management device 500 among the terminal device 300, the host vehicle M, and the parking lot management device 500 or a part or all of information stored in the storage unit 530 is lost will be described. Also, in the following, differences from the second control pattern will be mainly described and the description of common parts will be omitted.

### [Automated Entering]

In the third control pattern, automated entering cannot be performed when a failure occurs in the parking lot management device 500 and the information stored in the storage unit 530 cannot be updated. Thus, the output control unit 360 causes the display 330 to display information indicating that the automated entering process cannot be executed (for example, the above-described image IM4) as in the second control pattern.

### [Automated Leaving]

In the third control pattern, when a state of communication with the parking lot management device 500 is not normal at the time of leaving, the output control unit 360 generates an image for inquiring about whether or not to directly issue a leaving instruction to the host vehicle M and causes the generated image (for example, the above-described image IM5) to be displayed on the display 330.

The autonomous parking control unit 142 may generate a scheduled traveling route for causing the host vehicle M to travel so that an area of at least a part of the traveling route TR1 from the point P2 to the point P1 is reversely reproduced by setting the end point P2 of the traveling route TR1 included in the entry traveling route information 194 as a start point at the time of leaving and setting the start point P1 as an end point at the time of leaving or may cause the host vehicle M to autonomously travel to the stopping area 410 or the gate 400-out. Also, the autonomous parking control unit 142 causes the storage unit 190 to temporarily store the time when the host vehicle M left the parking space PS, the time when the host vehicle M passed through the gate 400-out, or the like.

[Process of Parking Lot Management Device 500 when Communication State is Restored]

Next, a process of the parking lot management device 500 when the communication state has been restored will be described. The parking situation management unit 524 of the parking lot management device 500 manages a parking situation in which the vehicle enters or leaves the parking lot. Here, when the communication state is determined to be abnormal by the communication state management unit 522, the parking situation management unit 524 cannot manage a leaving situation or an entering situation of vehicles for the parking lot PA and the parking space state table 534 is not updated. In this case, the parking situation management unit 524 performs a process of once resetting the information of the parking space state table 534 and recreating (reconstructing) the parking space state table 534. Also, until the process of reconstructing the parking space state table 534 ends, a process in which the host vehicle M enters and leaves the parking lot PA is temporarily restricted. When the communication state management unit 522 recognizes that the communication state has been changed (restored) from the abnormal state to the normal state, the parking space state table 534 is recreated.

In this case, the parking situation management unit 524 communicates with the vehicle present within the parking lot PA via the communication unit 510 and causes an inquiry about the parking situation to be transmitted. The parking situation inquired about includes, for example, information such as position information and a vehicle ID of a vehicle, a situation of the vehicle, an entering time of the vehicle, a scheduled leaving time of the vehicle, and the like. The situation of the vehicle includes, for example, information about a situation such as parking, entering, or leaving in progress. The parking situation management unit 524 adds an inquiry result obtained from each vehicle to the parking space state table 534. When the reconstruction of the parking space state table 534 is completed, temporarily restricting the host vehicle M from entering and leaving the parking lot PA is released.

Also, the parking space state table 534 may include request or reservation information (hereinafter referred to as “designation of a platform”) when a request of the user U for use conditions of the stopping area 410 (an example of a platform) and the getting-into/out area 420 (for example, a case in which the user wants to use a priority space with a slope or the like), a reservation of the stopping area 410, or the like is accepted.

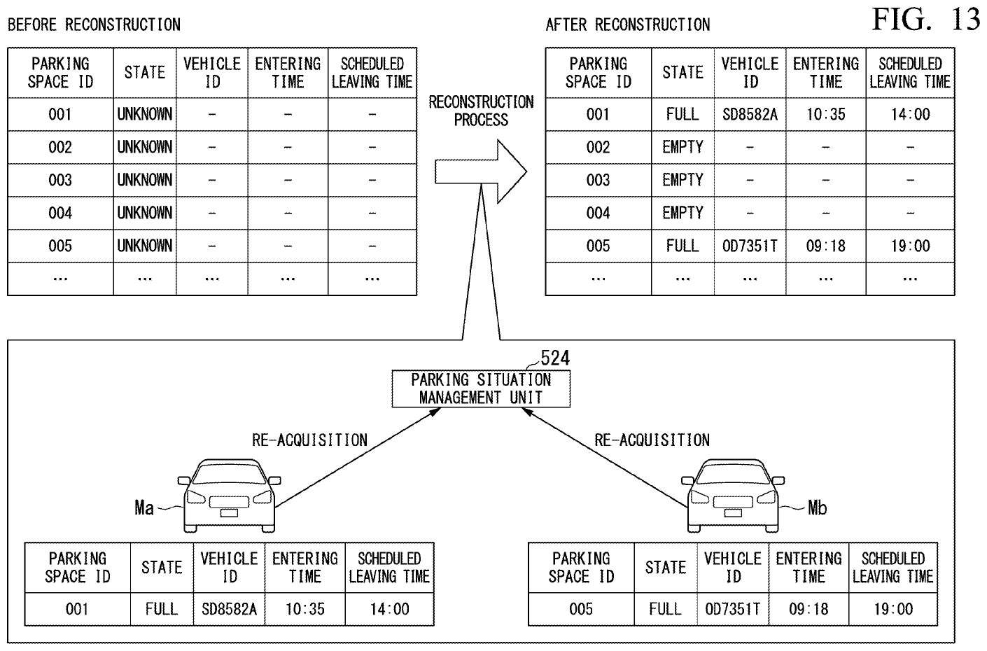

FIG. 13 is a diagram for describing a process in which the parking situation management unit 524 reconstructs the parking space state table 534. For example, when the communication state between the parking lot management device 500 and the vehicle parked in the parking lot PA has been restored, the parking situation management unit 524 requests all the vehicles using the parking lot PA to transmit information of the parking situations. Each vehicle transmits some or all of an ID of the parking space in use, an entering time, a movement trajectory at the time of entering, a scheduled departure time, and the presence or absence of designation of the platform used by the vehicle among items of information stored in the storage unit 190 of the host vehicle to the parking lot management device 500.

For example, as shown in FIG. 13, the parking situation management unit 524 acquires information stored in the storage unit 190 of a vehicle Ma such as a vehicle ID, an entering time, and a scheduled departure time from the vehicle Ma using a parking space ID “001”. Also, as shown in FIG. 13, the parking situation management unit 524 acquires information stored in the storage unit 190 of a vehicle Mb such as a vehicle ID, an entering time, and a scheduled departure time from the vehicle Mb using a parking space ID “005”. The parking situation management unit 524 sets information indicating a “full” state (for example, “full”) in the “state” associated with parking space IDs “001” and “005” in the parking space state table 534. Also, in the reconstruction process, the parking situation management unit 524 may determine that the states associated with the parking space IDs (for example, parking space IDs “002” to “004” shown in FIG. 13) for which no response has been obtained for a predetermined time period or more are the empty states.

Also, when communication between the parking lot management device 500 and an external device is possible, the parking situation management unit 524 may communicate directly with the host vehicle M that has left while the communication state was abnormal and recognize that the vehicle has already left.

Also, when an external device (hereinafter referred to as an alternative device) that performs an alternative process is provided if the communication state of the parking lot management device 500 is abnormal, the parking situation management unit 524 may acquire information of a vehicle that has left while the communication state was abnormal from the alternative device. For example, the alternative device is a device capable of communicating with the host vehicle M or a device capable of acquiring an imaging result of a camera (not shown) for imaging the inside of the parking lot PA. The alternative device records the time when the host vehicle M left the parking space PS or the time when the host vehicle M passed through the gate 400-out while the communication state between the parking lot management device 500 and the terminal device 300 was abnormal. After the communication state is restored, the parking situation management unit 524 acquires information of the vehicle that has left from the alternative device.

Thereby, the parking lot management device 500 can appropriately perform the entering control or the leaving control of the vehicle after the communication state is restored by reconstructing the parking space state table 534.

Also, although automated entering and automated leaving when the communication state of the parking lot management device 500 is abnormal have been described in the second control pattern and the third control pattern described above, it is not possible to transmit an automated entering request or an automated leaving request to the parking lot management device 500 or to transmit an automated entering instruction or an automated leaving instruction to the host vehicle M, for example, when the communication state of the terminal device 300 is not normal. Also, when the communication state of the host vehicle M is abnormal, it is not possible to receive an automated entering instruction or an automated leaving instruction from the parking lot management device 500 or the terminal device 300, so that the automated entering or automated leaving cannot be executed.

### [Process Flow]

Next, a flow of a process to be executed by the vehicle system 1 and the like of the embodiment will be described using flowcharts. Also, in the following, a process to be executed by the terminal device 300, an automated entering process and an autonomous leaving process to be executed by the automated driving control device 100, and a process after the restoration of the communication state to be executed by the parking lot management device 500 will be described separately.

### [Process to be Executed by the Automated Driving Control Device 100]

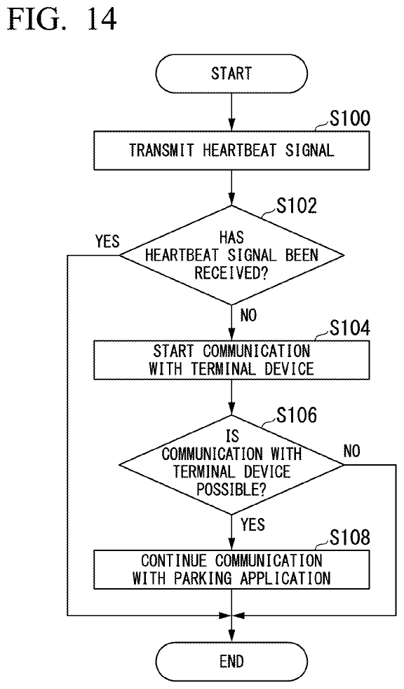

FIG. 14 is a flowchart showing an example of a flow of a process performed by the automated driving control device 100 according to the embodiment. In the example of FIG. 14, the automated driving control device 100 transmits a heartbeat signal to the parking lot management device 500 via the communication device 20 at a predetermined timing (step S100). Next, the automated driving control device 100 determines whether or not the heartbeat signal has been received from the parking lot management device 500 via the communication device 20 (step S102). When it is determined that the heartbeat signal has been received, the automated driving control device 100 ends a process of the present flowchart. When it is determined that the heartbeat signal has not been received, the automated driving control device 100 starts communication with the terminal device 300 (step S104).

Next, the automated driving control device 100 determines whether or not communication with the terminal device 300 is possible (step S106). When the automated driving control device 100 determines that communication with the terminal device 300 is not possible, the process of the present flowchart ends. When the automated driving control device 100 determines that communication with the terminal device 300 is possible, communication with the parking application 372 of the terminal device 300 is continued (step S108). Thereby, the description of the process of the present flowchart ends.

### [Process to be Executed by Parking Lot Management Device 500]

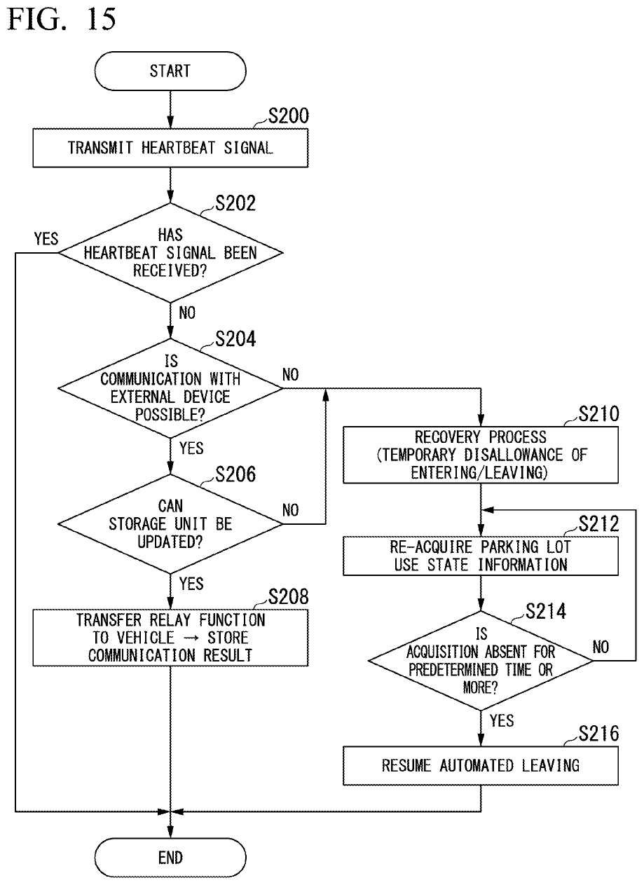

FIG. 15 is a flowchart showing an example of a flow of a process to be executed by the parking lot management device 500 according to the embodiment. In the example of FIG. 15, the communication state management unit 522 of the parking lot management device 500 transmits a heartbeat signal to the host vehicle M (the automated driving control device 100) via the first communication unit 512 (step S200). Next, the communication state management unit 522 determines whether or not the heartbeat signal has been received from the host vehicle M via the first communication unit 512 (step S202). When it is determined that the heartbeat signal has been received from the host vehicle M, the process of the present flowchart ends. When it is determined that the heartbeat signal has not been received from the host vehicle M, the communication state management unit 522 determines whether or not the second communication unit 514 can communicate with an external device (for example, the terminal device 300) (step S204). When it is determined that communication with the external device is possible, the communication state management unit 522 determines whether or not the storage unit 530 can be updated (step S206). When it is determined that the storage unit 530 can be updated, the parking lot management device 500 transfers the relay function to the host vehicle M, acquires communication results of the host vehicle M and the terminal device 300, and causes the storage unit 530 to store the communication results (step S208).

When it is determined that communication with the external device is not possible in step S204 or when it is determined that the storage unit 530 cannot be updated in step S206, the parking situation management unit 524 temporarily disallows an entering and leaving process of the vehicle in the parking lot PA and performs a recovery process after the communication situation is restored (a process of requesting all vehicles using the parking lot PA to transmit parking situation information) (step S210). Next, the parking situation management unit 524 re-acquires usage situation information of the parking lot PA from all the vehicles using the parking lot PA (step S212) and determines whether or not a state in which information is not acquired from a vehicle has continued for a predetermined time period or more (step S214). When the re-acquisition of the information from the vehicle is within the predetermined time period, the process returns to step S212. When it is determined that the state in which information from the vehicle is not acquired has continued for the predetermined time period or more, the parking lot management device 500 releases the restriction on the leaving of the vehicle and resumes the acceptance of automated leaving of the host vehicle M using the parking lot PA (step S216). Thereby, the process of the present flowchart ends. Also, in step S216, the acceptance of the automated entering may also be resumed.

### [Process to be Executed by Terminal Device 300]

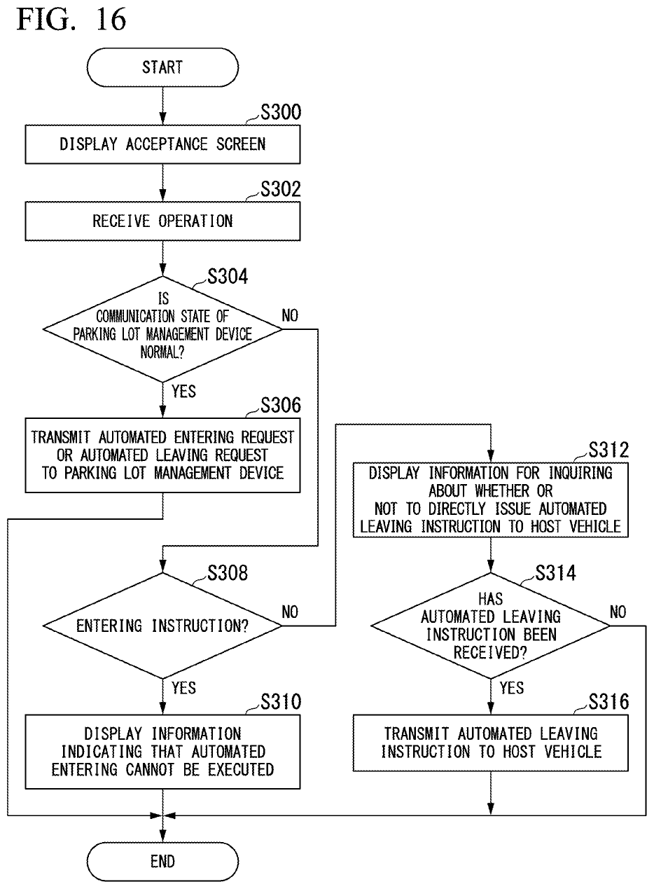

FIG. 16 is a flowchart showing an example of a flow of a process to be executed by the terminal device 300 according to the embodiment. In the example of FIG. 16, the output control unit 360 causes an acceptance screen (for example, the image IM1 or the image IM3) for accepting automated entering or automated leaving to be displayed at a predetermined timing (step S300). Next, the input unit 320 receives an operation from the user U (step S302). Also, in the processing of step S302, the input unit 320 may receive an input of a scheduled leaving time from the user U. Next, the application execution unit 350 determines whether or not the communication state of the parking lot management device 500 is normal (step S304). When it is determined that the communication state is normal, the application execution unit 350 transmits an automated entering request or an automated leaving request that has been received to the parking lot management device 500 together with a vehicle ID of the target vehicle (step S306).

Also, when it is determined that the communication state of the parking lot management device 500 is not normal in the processing of step S304, the application execution unit 350 determines whether or not a received operation detail is an entering instruction (step S308). When it is determined that the received operation detail is an entering instruction, the output control unit 360 causes the display 330 to display information (for example, the image IM4) indicating that automated entering cannot be executed (step S310).

Also, when it is determined that the received operation detail is not an entering instruction in the processing of step S308, it is determined that the received operation detail is a leaving instruction. In this case, the output control unit 360 causes the display 330 to display information (for example, the image IM5) for inquiring about whether or not to directly issue an automated leaving instruction to the host vehicle M (step S312). Next, the input unit 320 determines whether or not an automated leaving instruction has been received (step S314). When it is determined that the automated leaving instruction has been received, the application execution unit 350 transmits an autonomous leaving instruction to the host vehicle M via the communication unit 310 (step S316). Thereby, the process of the present flowchart ends. When it is determined that the automated leaving instruction has not been received in step S314, the process of the present flowchart ends.

According to the above-described embodiment, the parking lot management system S includes the host vehicle M using the parking lot PA; the parking application 372 to be executed by the terminal device 300 used by a user of the vehicle; and the parking lot management device 500 which is capable of communicating with the host vehicle M and the parking application 372 and manages at least one of a parking position, a movement trajectory, and a movement order of the host vehicle M using the parking lot PA, wherein, when communication with the parking application 372 is not normal, the parking lot management device 500 causes the host vehicle M and the parking application 372 to directly communicate with each other and acquires a communication result, so that more appropriate operation control can be executed in a situation in which the host vehicle M travels in an area including the parking lot.

Also, according to the embodiment, for example, because it is possible to cause the vehicle to leave while following the traveling route at the time of entering even though the communication state between the host vehicle M and the parking lot management device 500 is abnormal (not normal), it is possible to perform leaving control with higher safety without requiring the guidance of the parking lot management device 500.

### [Hardware Configuration]

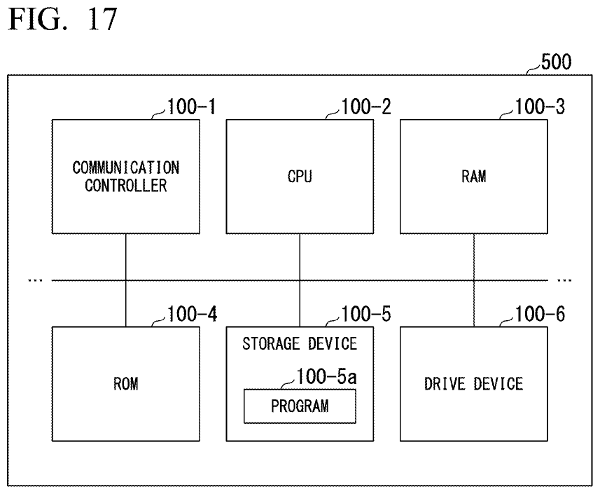

FIG. 17 is a diagram showing an example of a hardware configuration of the automated driving control device 100 of the embodiment. As shown in FIG. 17, a computer of the automated driving control device 100 has a configuration in which a communication controller 100-1, a CPU 100-2, a RAM 100-3 used as a working memory, a ROM 100-4 storing a boot program and the like, a storage device 100-5 such as a flash memory or a HDD, a drive device 100-6, and the like are mutually connected by an internal bus or a dedicated communication line. The communication controller 100-1 communicates with components other than the automated driving control device 100. A portable storage medium such as an optical disk (for example, a computer-readable non-transitory storage medium) is mounted on the drive device 100-6. The storage device 100-5 stores a program 100-5a to be executed by the CPU 100-2. This program is loaded into the RAM 100-3 by a direct memory access (DMA) controller (not shown) or the like and executed by the CPU 100-2. The program 100-5a referred to by the CPU 100-2 may be stored in a portable storage medium mounted on the drive device 100-6 or may be downloaded from another device via a network. Thereby, some or all of the components of the automated driving control device 100 are implemented.

The above-described hardware configuration described above can also be applied as an example of the hardware configuration of the parking lot management device 500 of the embodiment. In this case, the computer of the parking lot management device 500 includes a configuration in which a communication controller 100-1, a CPU 100-2, a RAM 100-3 used as a working memory, a ROM 100-4 storing a boot program and the like, and a storage device100-5 such as a flash memory or an HDD, a drive device 100-6, and the like are interconnected by an internal bus or a dedicated communication line. Thereby, some or all of the components of the parking lot management device 500 are implemented.

The embodiment described above can be represented as follows.

A parking lot management system for executing a parking lot management method to be executed by an in-vehicle communication device mounted in a vehicle, a vehicle control application to be executed by a terminal device used by a user of the vehicle and having a communication function, and a parking lot management device which is capable of communicating with the in-vehicle communication device and the terminal device, the parking lot management system including:

a storage device storing a program; and

a hardware processor,

wherein the hardware processor executes the program stored in the storage device,

whereby the parking lot management device manages at least one of a parking position, a movement trajectory, and a movement order of the vehicle using the parking lot in accordance with an instruction from the vehicle control application, and

whereby, when communication between the parking lot management device and the terminal device is not normal, the in-vehicle communication device and the terminal device perform communication and acquire information from the vehicle control application, and the information acquired from the vehicle control application is transmitted from the in-vehicle communication device to the management device.

Although modes for carrying out the present invention have been described using embodiments, the present invention is not limited to the embodiments, and various modifications and substitutions can also be made without departing from the scope and spirit of the present invention.

What is claimed is:

1. A parking lot management system comprising:
an in-vehicle communication device mounted in a vehicle, a vehicle control application to be executed by a terminal device used by a user of the vehicle and having a communication function, and a management device which is capable of communicating with the in-vehicle communication device and the terminal device and manages at least one of a parking position, a movement trajectory, and a movement order of the vehicle using a parking lot in accordance with an instruction from the vehicle control application,
wherein, when communication between the management device and the terminal device has succeeded, the in-vehicle communication device acquires the instruction from the vehicle control application via the management device, and
wherein, when the communication between the management device and the terminal device has failed, the in-vehicle communication device acquires information from the vehicle control application through communication with the terminal device, transmits the information acquired from the vehicle control application to the management device, and transmits a result of communicating with the management device to the vehicle control application.

2. The parking lot management system according to claim 1, wherein the management device manages at least one of the parking position, the movement trajectory, and the movement order of the vehicle using the parking lot on the basis of information acquired from the in-vehicle communication device.

3. The parking lot management system according to claim 1, wherein the management device communicates with the terminal device, acquires information from the vehicle control application, accumulates the information in a storage unit, and transmits a processing result to the vehicle control application.

4. The parking lot management system according to claim 1,
wherein the management device causes parking lot use state information, which is information about a use state of the parking lot, to be stored in a storage unit and manages the parking lot use state information, and
wherein, when the parking lot use state information has been reset, the management device acquires a part or all of information of vehicles using the parking lot from the in-vehicle communication device and reconstructs the parking lot use state information on the basis of the acquired information.

5. The parking lot management system according to claim 4, wherein the parking lot use state information includes some or all of a parking lot entering time of the vehicle, a movement trajectory at the time of entering, a scheduled departure time, and the presence or absence of designation of a platform to be used by the vehicle.

6. The parking lot management system according to claim 4, wherein, when the parking lot use state information has been reset, the management device temporarily restricts the vehicle from entering and leaving the parking lot.

7. The parking lot management system according to claim 6, wherein, when a state in which there is no acquisition of information from the in-vehicle communication device has continued for a predetermined time period or more, the management device determines that reconstruction of the parking lot use state information has been completed and releases the restriction on the leaving of the vehicle.

8. A parking lot management device including a first communication unit configured to communicate with an in-vehicle communication device mounted in a vehicle within a parking lot, a second communication unit configured to communicate with a terminal device used by a user of the vehicle, and a control unit configured to integrate a result of communication of the first communication unit with the in-vehicle communication device and a result of communication of the second communication unit with the terminal device to control a parking lot use state of the vehicle,
wherein, when the communication of the second communication unit has failed, the control unit causes the first communication unit to acquire a result of direct communication of the in-vehicle communication device with the terminal device from the in-vehicle communication device.

9. A parking lot management method to be executed by an in-vehicle communication device mounted in a vehicle, a vehicle control application to be executed by a terminal device used by a user of the vehicle and having a communication function, and a management device which is capable of communicating with the in-vehicle communication device and the terminal device, the parking lot management method comprising:
managing, by the management device, at least one of a parking position, a movement trajectory, and a movement order of the vehicle using the parking lot in accordance with an instruction from the vehicle control application;
when communication between the management device and the terminal device has succeeded, acquiring, by the in-vehicle communication device, the instruction from the vehicle control application via the management device; and
when communication between the management device and the terminal device has failed, acquiring, by the in-vehicle communication device, information from the vehicle control application through communication with the terminal device, transmitting the information acquired from the vehicle control application to the management device, and transmitting a result of communicating with the management device to the vehicle control application.

10. A computer-readable non-transitory storage medium storing a program for causing a computer of a management device including a first communication unit configured to communicate with an in-vehicle communication device mounted in a vehicle within a parking lot and a second communication unit configured to communicate with a terminal device used by a user of the vehicle to:
integrate a result of communication of the first communication unit with the in-vehicle communication device and a result of communication of the second communication unit with the terminal device to control a parking lot use state of the vehicle;
when the communication of the second communication unit has succeeded, cause the first communication unit to receive an instruction from the user via the management device; and
when the communication of the second communication unit has failed, cause the first communication unit to acquire a result of direct communication of the in-vehicle communication device with the terminal device from the in-vehicle communication device.
